(19) United States
(12) Patent Application Publication
(10) Pub. No.: US 2008/0258871 A1
(43) Pub. Date: Oct. 23, 2008

(54) PORTABLE AUDIO-CAPABLE DEVICE SYSTEMS, IN PARTICULAR HEARING SYSTEMS, PLAYING MESSAGES

(75) Inventor: Bernd Waldmann, Maur (CH)

Correspondence Address: PEARNE & GORDON LLP, 1801 EAST 9TH STREET, SUITE 1200, CLEVELAND, OH, 44114-3108, US

(73) Assignee: PHONAK AG, Staefa (CH)

(21) Appl. No.: 11/736,719

(22) Filed: Apr. 18, 2007

(51) Int. Cl. G08B 23/00

(52) U.S. Cl. 340/7.51

(57) ABSTRACT

A method includes the step of providing a user of a portable audio-capable device system, such as a hearing system, with a benefit as a reward for the user's consent to accept that said portable audio-capable device system plays messages, in particular audible messages. In particular, the benefit includes providing at no cost, or providing a deduction in payments for, at least one of: a device of said portable audio-capable device system; an accessory for said portable audio-capable device system; a functionality for said portable audio-capable device system; and goods or services contributing to operating costs of said portable audio-capable device system. Accordingly, the user accepts that he is confronted with specific audible messages, and in return, he is provided with a benefit, in particular with a financial benefit. Accordingly, the user can be sponsored, e.g., by the manufacturer of said portable audio-capable device system.

The International patent application of the same inventor titled “Hearing System and Method for Operating the same” filed on the same day as the present application, is herewith incorporated by reference in its entirety in this present application.

### TECHNICAL FIELD

The invention relates to the field of portable audio-capable device systems, and in particular to sponsoring users of such systems.

Under a portable audio-capable device system, we understand a system, which is portable and which is capable of providing a user of the system with audible signals. A portable audio-capable device system comprises at least one device, which generates audio signals, wherein audio signals are electrical signals, analogue or digital, which represent sound. The same device or another device of said portable audio-capable device system is capable of converting said audio signals into said audible signals, typically acoustic signals (sound waves).

Optionally, a portable audio-capable device system comprises further devices, operationally connectable within said portable audio-capable device system, e.g., a remote control, a remote microphone.

Most of today's portable audio-capable device systems are digital portable audio-capable device systems, i.e. they comprise digital electronics and usually carry out processing of digital data such as digital audio signals.

A hearing system is an example of a portable audio-capable device system, which is of particular interest to the applicant. A hearing system comprises at least one hearing device. Typically, a hearing system comprises, in addition, at least one additional device, which is operationally connected to said hearing device, e.g., another hearing device, a remote control or a remote microphone.

Under a hearing device, a device is understood, which is worn in or adjacent to an individual's ear with the object to improve the individual's acoustical perception. Such improvement may also be barring acoustic signals from being perceived in the sense of hearing protection for the individual. If the hearing device is tailored so as to improve the perception of a hearing impaired individual towards hearing perception of a “standard” individual, then we speak of a hearing-aid device. With respect to the application area, a hearing device may be applied behind the ear, in the ear, completely in the ear canal or may be implanted.

### BACKGROUND OF THE INVENTION

Portable audio-capable device systems such as hearing devices, audio players and mobile phones are usually sold at a pre-determined price or at a price agreed upon after some negotiation. That price is paid in one or more payments. This applies also to accessories for such systems, and prices for services related to such systems are usually dealt with in that way, too.

It is desirable to find a way that allows a user of a portable audio-capable device system to save or earn money, at least in one of the above-mentioned transactions.

The concept of confronting a media contents consuming person with advertisements is well known from newspapers, magazines, TV and radio, wherein this makes it possible to provide said contents at a lower price.

In the field of sports, the concept of sponsoring is well known.

Although portable audio-capable device systems such as digital hearing devices, digital audio players, mobile phones are already known for a long time, and although the corresponding economic markets are very active, innovative and competitive, there is apparently a lack of innovation in financing such systems or making use of them in conjunction with advertisements.

### SUMMARY OF THE INVENTION

Therefore, one object of the invention is to create a method which provides a way of allowing a user of a portable audio-capable device system to save or earn money.

Another object of the invention is to provide a new use for portable audio-capable device systems.

Another object of the invention is to provide for a new way of doing business in conjunction with portable audio-capable device systems.

Another object of the invention is to provide for a method that allows a user of a portable audio-capable device system to afford something he usually would not afford.

Another object of the invention is to provide new marketing instruments in the field of portable audio-capable device systems.

Further objects emerge from the description and embodiments below.

At least one of these objects is at least partially achieved by methods and uses according to the patent claims.

The method comprises the step of providing a user of a portable audio-capable device system with a benefit as a reward for the user's consent to accept that said portable audio-capable device system plays messages, in particular audible messages. And in particular, said benefit comprises at least one of
providing at no cost;
providing a deduction in payments for;
   at least one of
a device of said portable audio-capable device system;
an accessory for said portable audio-capable device system;
a functionality of said portable audio-capable device system;
goods or services contributing to operating costs of said portable audio-capable device system.

Accordingly, said user accepts that he is confronted with specific messages, and in return, he is provided with a benefit, in particular with a financial benefit.

In particular, said user is rewarded for his consent to listening to messages played by said portable audio-capable device system.

Through this, new ways of doing business in the field of portable audio-capable device systems are provided. Said user can save or even earn money by this, and/or said user can be provided with goods or services, which he otherwise would not receive or only receive for paying (more) money.

The method can—considered under a slightly different point of view—also be interpreted as a method for sponsoring said user of said portable audio-capable device system.

Examples for said accessories are covers, wrappings, bags for said portable audio-capable device system or a device of said portable audio-capable device system, and memory extensions for said portable audio-capable device system.

Examples for said functionalities are specific signal processing capabilities of said portable audio-capable device system, or other capabilities extending the functionalities otherwise provided by said portable audio-capable device system.

Examples for said services are services for said portable audio-capable device system, in particular maintenance services such as updating or upgrading said system or a device of said system, cleaning said system or a device of said system, exchanging wearing parts of said system or of a device of said system, and providing said user with help concerning operating or handling said system or a device of said system. Said services do not comprise providing contents to be reproduced by said portable audio-capable device system. Costs for such contents are not considered to contribute to operating costs of said portable audio-capable device system.

Examples for said goods are batteries or wearing parts for said system or of a device of said system

The method proposes a give-and-take involving a user of a portable audio-capable device system. The user agrees to have his portable audio-capable device system play messages, and in return, the user receives a benefit.

Usually, said messages are played to said user, or are at least meant to be played to said user.

In one embodiment, said portable audio-capable device system is a digital portable audio-capable device system.

In one embodiment, said messages comprise advertising messages.

In one embodiment, said messages comprise messages which would not be played without said consent.

Said consent will typically be a consent individually and/or explicitly given by said user, which distinguishes said consent, e.g., from the implicit agreement of a person listening to a radio program comprising radio commercials to be exposed to said radio commercials.

In one embodiment, said portable audio-capable device system comprises a device, which generates audio signals and converts those into said audible signals. This can be the case, e.g., if said system comprises a hearing device or a mobile phone. In another embodiment, said system comprises a device, which generates audio signals, and another device, which converts said audio signals into said audible signals. This can, e.g., be the case if said system comprises a headphone and an audio player such as an MP3-player, which comprises a connector for attaching an electrical-to-acoustic converter such as said headphone.

In one embodiment, said user can choose whether or not to accept that said portable audio-capable device system plays messages. Typically, it is the user's choice to accept or decline said playing of said messages.

In one embodiment, said user can choose at least one of
which messages are played;
one or more events upon which said messages are played.

This allows to adapt the portable audio-capable device system and in particular said playing of messages to the user's individual preferences.

It is also possible to provide no such choice or individualization.

In one embodiment, said user can choose one or more items and/or actions as said benefit.

And it is also possible to provide that said user can choose one or more of said messages. In that case, said user can make a selection from several messages and choose a number from those.

In one embodiment, said portable audio-capable device system is adjustable to hearing preferences and in particular to hearing problems of said user. This applies, e.g., to hearing systems or some advanced audio players.

In one embodiment, said portable audio-capable device system comprises a hearing device. If the invention were confined to such systems comprising a hearing device, said messages played by the system could even comprise non-audible messages such as visual messages without audible messages, e.g., text messages shown in a display of a remote control of said system. Furthermore, if the invention were confined to such systems comprising a hearing device, said benefit could be any kind of benefit, also benefits fully or in part unrelated to said system.

In one embodiment, said portable audio-capable device system comprises a headphone.

In one embodiment, said portable audio-capable device system comprises an ear-phone.

In one embodiment, said portable audio-capable device system comprises an audio player such as a mobile CD player, an MP3 player, a iPod™, a portable radio.

In one embodiment, said portable audio-capable device system comprises a video player.

In one embodiment, said portable audio-capable device system comprises a game console.

In one embodiment, said portable audio-capable device system comprises a computing device such as a palm computing device.

In one embodiment, said portable audio-capable device system comprises a telephone such as a mobile phone, a cellular phone, a cordless phone, a WLAN (Wireless Local Area Network) VoIP (Voice over Internet Protocol) phone.

In one embodiment, said portable audio-capable device system comprises a hearing device and one of the above-cited devices.

In one embodiment, said portable audio-capable device system comprises a device embodying a hearing device and at least one other of the above-cited devices.

In one embodiment, said benefit is related to said portable audio-capable device system.

In one embodiment, said benefit is provided at least in part by at least one of
a manufacturer of said portable audio-capable device system;
a vendor of said portable audio-capable device system;
a business entity that wishes to present said messages;
a business entity contracted by another business entity to provide said benefit.

In one embodiment, said messages are played upon at least one of the following events:
a certain time of the day is reached;
the end of a regular time interval is reached;
a randomly chosen point in time is reached;
a pre-defined manipulation of said portable audio-capable device system is carried out;
a pre-defined event in said portable audio-capable device system has occurred;
said portable audio-capable device system is located in a pre-defined location.

Such a pre-defined event can be, e.g., putting said portable audio-capable device system into operation; or a pre-defined functionality of said portable audio-capable device system is selected; or a predefined functionality in the portable device is about to be activated, or had been activated for some time, or is about to be de-activated. An example for an audible message played in the latter case could be the spoken words “How did you like listening during the last five minute? You experienced the new Phonak Super Noise Canceller. If you want to use this functionality later on, please contact your audiologist.”

In one embodiment, said messages are related to said portable audio-capable device system.

In one embodiment, said messages are related to products available, e.g., food, clothes.

In one embodiment, said messages are related to services available, e.g., repair services.

In one embodiment, said messages are related to a business entity.

In one embodiment, said messages are related to an organisation, e.g., a political party, a club. In particular in this case, said messages can well be or comprise non-advertising announcements such as announcements concerning behavioral patterns, e.g., “Smoking kills” or “Don't drink and drive”.

In one embodiment, said messages are related to a manufacturer of portable audio-capable device systems and/or accessories therefor.

In one embodiment, said messages are related to a manufacturer of said portable audio-capable device system and/or accessories therefor.

In one embodiment, said messages are related to a vendor of portable audio-capable device systems and/or accessories therefor.

In one embodiment, said messages are related to a vendor of said portable audio-capable device system and/or accessories therefor.

In one embodiment, said messages comprise at least one of
a spoken message;
a jingle;
an acoustic icon, i.e. sounds that are intuitively understood, in particular sounds that are intuitively connected to a certain product or service, e.g., the sound of deep-frying something in a frying pan or the sound of opening a bottle and pouring a drink into a glass.

In one embodiment, said messages comprise control information. In that case, said method typically comprises the step of verifying that said user has perceived said messages in that the user has to enter information depending on said control information. E.g., within said messages, a number is communicated to the user, and the user has to enter that number in the portable audio-capable device system in order to be able to continue profiting from said benefit.

In one embodiment, data representing said messages are comprised in said portable audio-capable device system. E.g., there could be a storage unit within the portable audio-capable device system, which comprises data representative of a jingle to be played.

In one embodiment, data representing said messages are received in said portable audio-capable device system via a communication connection, in particular via a wireless communication link. A wirebound connection, such as provided by a cable or in a docking station, is also possible.

In one embodiment, for at least one of said messages, data defining at least one of
a number defining how many times said at least one of said messages is to be played;
a time span or point in time after which said at least one of said messages shall not be played anymore;
a time span or point in time after which said at least one of said messages shall firstly be played;
   are provided.

These data can, e.g., be provided within the portable audio-capable device system. This can help to control the number of messages said user shall perceive in return for said benefit.

In one embodiment, said method comprises the step of recording how often said messages have been played. This information can be used to keep track of the message playing. This information can be transmitted to, e.g., the provider of said messages.

In one embodiment, said method comprises the step of automatically adjusting the output level of said audible messages. This can help to ensure the audibility of said audible messages, even in noisy environments.

A use according to the invention is a use of a portable audio-capable device system for playing messages to a user of said portable audio-capable device system in return for providing said user with a benefit for said user's consent to accept said playing of said messages, wherein said benefit comprises

at least one of
providing at no cost;
providing a deduction in payments for;
   at least one of
a device of said portable audio-capable device system;
an accessory for said portable audio-capable device system;
a functionality for said portable audio-capable device system;
goods or services contributing to operating costs of said portable audio-capable device system.

It is pointed out, that the embodiments and variations of the invention described above can be combined with one another.

Further preferred embodiments and advantages emerge from the dependent claims and the figures.

### BRIEF DESCRIPTION OF THE DRAWINGS

Below, the invention is described in more detail by means of examples and the included drawings. The figures show:

FIG. 1 a schematic illustration of a method according to the invention;

FIG. 2 a schematic illustration of a method according to the invention;

FIG. 3 a schematic illustration of a method according to the invention.

The reference symbols used in the figures and their meaning are summarized in the list of reference symbols. The described embodiments are meant as examples and shall not confine the invention.

### DETAILED DESCRIPTION OF THE INVENTION

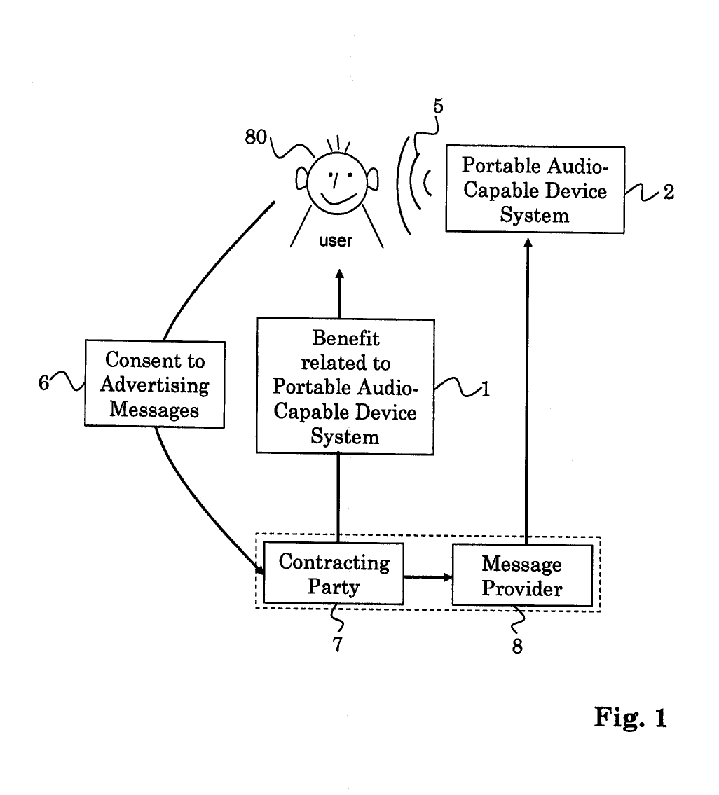

FIG. 1 shows a schematic illustration of a method according to the invention. A user 80 of a portable audio-capable device system 2 agrees with a contracting party 7 about the following: User 80 gives his consent 6 that his portable audio-capable device system 2 plays messages 5, and in return, user 80 is provided with a benefit 1. Consequently, portable audio-capable device system 2 plays messages 5, which are usually meant to be perceived by user 80. Said messages can be provided by a message provider 8. As indicated by the dashed rectangle, message provider 8 can be identical with or closely related to contracting party 7.

Said portable audio-capable device system 2 can, e.g., be a hearing system, an audio player such as an MP3 player or CD player with headphones. Said messages 5 are or comprise typically audible messages. In many cases, said messages 5 are advertising messages. Said consent 6 can be given orally, in written form or otherwise. Said benefit 1 is usually related to said portable audio-capable device system 2. It can mean that said contracting party provides user 80 with a discount on the price of the portable audio-capable device system 2 or of a device of the portable audio-capable device system 2 or an accessory. Or portable audio-capable device system 2 is provided with special functionalities such as special signal processing features, or operating costs of the portable audio-capable device system 2 are reduced for the user 80.

Said messages 5 are played, e.g., at regular times of the day, or upon specific events in the portable audio-capable device system 2, such as whenever the before-mentioned special signal processing features are used.

The method can be interpreted as a sponsoring of user 80 by contracting party 7, e.g., the vendor or manufacturer of portable audio-capable device system 2.

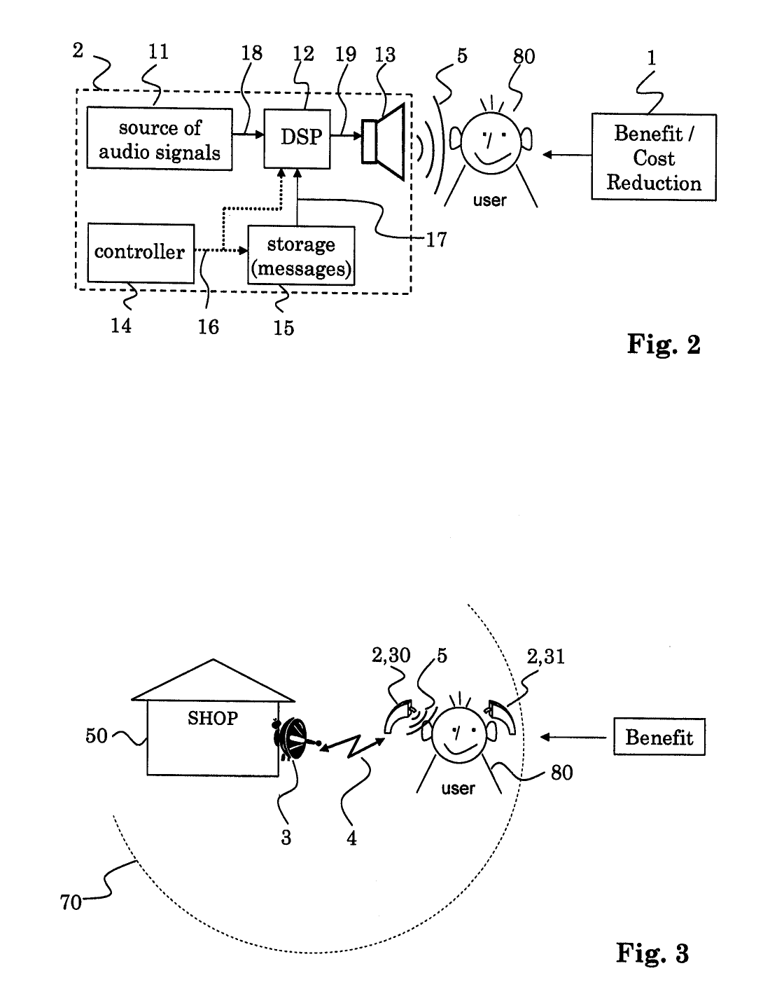

FIG. 2 shows a schematic illustration of a method according to the invention. In this Figure, the portable audio-capable device system 2 is shown in greater detail than in FIG. 1.

Portable audio-capable device system 2 comprises a source of audio signals 11, a signal processor 12, an output unit 13, a controller 14, and a storage unit 15. A user 80 usually uses a portable audio-capable device system 2 for perceiving audible signals originating from said source of audio signals 11, typically processed in signal processor 12, and output, typically by output unit 13. In case of an MP3 player with a headphone, said source of audio signals 11 can comprise a storage unit such as RAM modules or a memory stick or a CD, storing data representing audio signals 18, and these are, after conversion into audio signals 19 by processing in signal processor 12, converted into sound by output unit 13, e.g., said headphone connected to an audio output of said MP3 player. In case of a hearing system as portable audio-capable device system 2, said source of audio signals 11 typically comprises a microphone unit, which converts sound into audio signals 18, and these are, after conversion into audio signals 19 by processing in signal processor 12, converted into sound by output unit 13, typically at least one loudspeaker—typically referred to as receiver—of the hearing system. In case of a radio as portable audio-capable device system 2, said source of audio signals comprises an FM receiver.

Upon certain, usually pre-defined events, the above-described usually perceived audible signals are replaced by or augmented with specific messages 5. Said controller 14 detects that a corresponding event takes place and sends a control signal 16 to signal processor 12 and/or storage unit 15. Thereupon, audio signals 17 representing a message to be played are transmitted from storage unit 15 to signal processor 12, and—after conversion into audio signals 19 by processing—converted into message 5.

Data representing said messages 5 can be stored in storage unit 15 already by the manufacturer, or by the vendor. It is also possible to load such data—in a wireless or in a wirebound fashion—into storage unit 15 upon certain events, e.g., when the user puts the portable audio-capable device system 2 into a docking station, and/or connects it to a computer accessing a certain site of the internet, or when the portable audio-capable device system 2 is located in a location in which a suitable wireless communication link is available.

As a reward for his consent to this playing of messages, user 80 is provided with benefit 1, e.g., with a cost reduction related to his portable audio-capable device system 2.

FIG. 3 shows a schematic illustration of a method according to the invention. In this embodiment, one event upon which a message is played, is that the portable audio-capable device system 2 is located within a communication range 70 of a communication unit 3, which is, e.g., located at or near a specific location 50, e.g., a shop. A detection that the portable audio-capable device system 2 is located within said communication range 70 can be accomplished within the portable audio-capable device system 2 or by a unit operationally connected to said communication unit 3, located at said location 50 or remote. It is possible to use data stored within the portable audio-capable device system 2 representing said messages 5 for generating said audible messages 5. But it is also possible to transmit data representing said messages 5 via a communication link 4 between said communication unit 3 and said portable audio-capable device system 2. In FIG. 3, a hearing system comprising two hearing devices 31,32 is shown as portable audio-capable device system 2. If, e.g., said location 50 is an audiologist's office, the audiologist could transmit to said user data representing messages comprising information about current special offers.

For further details on location-dependent behavior of portable audio-capable device systems and for further embodiments in which a message 5 is played in dependence of a detection that at least a part of said portable audio-capable device system 2 is located in a specific location, it is referred to the above-mentioned International patent application of the same inventor titled “Hearing System and Method for Operating the same”, which is incorporated in this application. Although the embodiments disclosed therein refer to hearing systems as portable audio-capable device systems only, it is as well possible to realize these embodiments with other portable audio-capable device systems.

Some further concrete embodiments of the invention will be given in the following:

In one example, a person wants to buy a portable audio-capable device system, e.g., an audio player. The vendor offers to him that only half the usual price has to be payed if it is accepted that the audio player plays advertising messages of the vendor or of the manufacturer of the audio player every hour when the audio player is switched on. Said person agrees, becomes the user of the audio player, and receives a reward—the price reduction—in return to his consent to said message playing. Possibly, the user can choose from different messages, in particular messages of different durations, and/or from different events upon which the messages are played, e.g., each time the audio player is switched on or before every new piece of music played by the audio player, and possibly, the benefit, e.g., the amount of price reduction, depends on such a choice.

Instead of a reduced price, it is also possible to offer and receive batteries for free or at a reduced price for a certain time or as long as it is accepted that said messages are played.

In another example, the contracting party is a fast-food chain or related thereto or another business entity, which acts on behalf of said fast-food chain. The user receives a benefit related to his portable audio-capable device system and in return accepts that his portable audio-capable device system plays a jingle related to said fast-food chain every time the portable audio-capable device system is located within the communication range of wireless networks to which the portable audio-capable device system can connect, and which are typically located at or near branches of said fast-food chain. The message can also comprise information loaded from such a wireless network, e.g, “Today we offer free french fries with each hambuger”. Accordingly, the user is sponsored by said fast-food chain. Messages could also be played every day at half past twelve and at six thirty in the evening, when one typically becomes hungry, or at random times, which makes it harder for the user to avoid hearing the messages.

In another example, an organisation, e.g., an organization fighting alcohol abuse, sponsors portable audio-capable device systems, e.g., by offering a reduced price of the portable audio-capable device system. In return, users of portable audio-capable device systems have to listen to messages such as “Don't drink and drive!” every 30 minutes from 8 p.m. to midnight.

In particular in case of hearing systems as portable audio-capable device systems, the provision of specific functionalities of the hearing system, e.g., a specific noise canceller or beam former, can be provided to the user, if the user consents to messages being played, e.g., messages played each time after said specific functionality has been used, e.g., “You just used the brand new beam former.”

In the case of hearing systems as portable audio-capable device systems, it can be advisable to present the user with visual messages in addition to or instead of audible messages. Such visual messages can, e.g., be displayed in a display of a remote control of the hearing system.

Several refinements of methods according to the invention are possible. For example, while a message is played, some control information is played, which control information has to be reproduced by the user, e.g., by entering the control information in the portable audio-capable device system or at a specific site in the internet. For example, it is played by the portable audio-capable device system: “Don't forget that the best products are available from XYZ company. Enter the control code 15-16-17 into your remote control by tonight.” If the user does not enter the control information (“15-16-17”) in time, he will not be able to profit from his benefit any longer, e.g., some specific functionalities of his portable audio-capable device system will be disabled. This is a way to ensure that the played messages are not only played, but also perceived.

Another way to attempt this goal is to set the output volume of the portable audio-capable device system specifically, when the audible messages are played.

Another refinement comprises that it is logged, usually in the portable audio-capable device system, how many times messages have been played, The logged information can be transmitted to the contracting party for control reasons.

### LIST OF REFERENCE SYMBOLS

1 benefit
2 portable audio-capable device system
3 communication unit
4 communication connection
5 message, audible message, advertising message
6 consent
7 contracting party, business entity, organisation, manufacturer, vendor
8 message provider
11 source of audio signals
12 signal processor
13 output unit, output converter
14 control unit
15 storage unit
16 control signals
17 audio signals
18 audio signals
19 audio signals
30 device of portable audio-capable device system, hearing device
31 device of portable audio-capable device system, hearing device
50 location, shop
70 communication range
80 user

1. Method comprising the step of providing a user of a portable audio-capable device system with a benefit as a reward for the user's consent to accept that said portable audio-capable device system plays audible messages, wherein said benefit comprises
at least one of
providing at no cost;
providing a deduction in payments for;
at least one of
a device of said portable audio-capable device system;
an accessory for said portable audio-capable device system;
a functionality of said portable audio-capable device system;
goods or services contributing to operating costs of said portable audio-capable device system.

2. The method according to claim 1, wherein said audible messages comprise advertising messages.

3. The method according to claim 1, wherein said audible messages comprise messages which would not be played without said consent.

4. The method according to claim 1, wherein said user can choose whether or not to accept that said portable audio-capable device system plays audible messages.

5. The method according to claim 1, wherein said user can choose at least one of
which audible messages are played;
one or more events upon which said audible messages are played.

6. The method according to claim 1, wherein said portable audio-capable device system is adjustable to hearing preferences of said user.

7. The method according to claim 1, wherein said portable audio-capable device system comprises a hearing device.

8. The method according to claim 1, wherein said portable audio-capable device system comprises at least one of
a hearing device;
a headphone;
an ear-phone;
an audio player;
a video player;
a game console;
a computing device;
a telephone.

9. The method according to claim 1, wherein said benefit is related to said portable audio-capable device system.

10. The method according to claim 1, wherein said benefit is provided at least in part by at least one of
a manufacturer of said portable audio-capable device system;
a vendor of said portable audio-capable device system;
a business entity that wishes to present said audible messages;
a business entity contracted by another business entity to provide said benefit.

11. The method according to claim 1, wherein said audible messages are played upon at least one of the following events:
a certain time of the day is reached;
the end of a regular time interval is reached;
a randomly chosen point in time is reached;
a pre-defined manipulation of said portable audio-capable device system is carried out;
a pre-defined event in said portable audio-capable device system has occurred;
said portable audio-capable device system is located in a pre-defined location.

12. The method according to claim 1, wherein said audible messages are related to at least one of
said portable audio-capable device system;
products available;
services available;
a business entity;
an organisation;
a manufacturer of portable audio-capable device systems and/or accessories therefor;
a manufacturer of said portable audio-capable device system and/or accessories therefor;
a vendor of portable audio-capable device systems and/or accessories therefor;
a vendor of said portable audio-capable device system and/or accessories therefor.

13. The method according to claim 1, wherein said audible messages comprise at least one of
a spoken message;
a jingle;
an acoustic icon.

14. The method according to claim 1, wherein said audible messages comprise control information, and wherein said method comprises the step of verifying that said user has perceived said audible messages in that the user has to enter information depending on said control information.

15. The method according to claim 1, wherein data representing said audible messages are at least one of
comprised in said portable audio-capable device system;
received in said portable audio-capable device system via a communication connection.

16. The method according to claim 1, wherein for at least one of said audible messages, data defining at least one of
a number defining how many times said at least one of said audible messages is to be played;
a time span or point in time after which said at least one of said audible messages shall not be played anymore;
a time span or point in time after which said at least one of said audible messages shall firstly be played;
are provided.

17. The method according to claim 1, which comprises the step of recording how often said audible messages have been played.

18. The method according to claim 1, which comprises the step of automatically adjusting the output level of said audible messages.

19. Use of a portable audio-capable device system for playing audible messages to a user of said portable audio-capable device system in return for providing said user with a benefit for said user's consent to accept said playing of said audible messages, wherein said benefit comprises
at least one of
providing at no cost;
providing a deduction in payments for;
at least one of
a device of said portable audio-capable device system;
an accessory for said portable audio-capable device system;
a functionality for said portable audio-capable device system;
goods or services contributing to operating costs of said portable audio-capable device system.

20. The method according to claim 19, wherein said audible messages comprise advertising messages.

21. The method according to claim 19, wherein said audible messages comprise messages which would not be played without said consent.

22. The method according to claim 19, wherein said portable audio-capable device system comprises a hearing device.

23. The method according to claim 19, wherein said portable audio-capable device system comprises at least one of
a hearing device;
a headphone;
an ear-phone;
an audio player;
a video player;
a game console;
a computing device;
a telephone.
